(19) United States
(12) Patent Application Publication
(10) Pub. No.: US 2017/0060523 A1
(43) Pub. Date: Mar. 2, 2017

(54) ELECTRONIC DEVICE AND CONTROLLING METHOD THEREOF

(71) Applicant: SAMSUNG ELECTRONICS CO., LTD., Suwon-si (KR)

(72) Inventors: Ji-min HONG, Seoul (KR); Ji-youn HAN, Seoul (KR); Joon-soo KIM, Seoul (KR); Ji-gwang KIM, Seoul (KR)

(73) Assignee: SAMSUNG ELECTRONICS CO., LTD., Suwon-si (KR)

(21) Appl. No.: 15/233,373

(22) Filed: Aug. 10, 2016

(30) Foreign Application Priority Data
Sep. 2, 2015 (KR) 10-2015-0124332

(51) Int. Cl. G06F 3/16; G06F 3/01; G06F 3/0484; G06F 3/0481

(52) U.S. Cl. CPC G06F 3/165; G06F 3/04817; G06F 3/017; G06F 3/04845; G06F 3/167

(57) ABSTRACT

An electronic device and a controlling method thereof are provided. The electronic device may include a microphone configured to receive sound and generate an audio signal based on the sound; a communicator configured to perform communication with an external device; and a controller configured to control the communicator to transmit the audio signal to external device and receive information regarding music content corresponding to the audio signal from the external device.

### CROSS-REFERENCE TO RELATED APPLICATIONS

This application claims priority from Korean Patent Application No. 10-2015-0124332, filed in the Korean Intellectual Property Office on Sep. 2, 2015, the disclosure of which is incorporated herein by reference.

### BACKGROUND

1. Field

Methods and apparatuses consistent with exemplary embodiments relate to providing a user with information regarding music content, and more particularly, to providing a user with information regarding music content corresponding to a sound signal received from an external sound source.

2. Description of the Related Art

With the development of information technologies, a method for a user to obtain music contents has advanced in many aspects. In the past, users had to purchase music contents recorded on an off-line medium, such as a Compact Disk (CD), a tape, etc. However, now, users can use on-line music contents.

A sound source search service enables a user to search music content corresponding to an external sound source in the neighborhood. The sound source search service is provided such that an external sound source service is executed, and by approaching an electronic device where the search service is being executed to a sound source, a search result page is provided.

Therefore, a user needs to execute a sound source search service in his device every time he or she wishes to search a sound source, which causes inconvenience. In addition, there is no way to make up a playlist using the searched sound sources.

### SUMMARY

One or more exemplary embodiments provide an electronic device capable of collecting an external sound source and providing information regarding the sound source to a user and a control method thereof.

According to an aspect of an exemplary embodiment, there is provided an electronic device including: a microphone configured to receive sound and generate an audio signal based on the sound; a communicator configured to perform communication with an external device; and a controller configured to control the communicator to transmit the audio signal to external device and receive information regarding music content corresponding to the audio signal from the external device.

The electronic device may further include a display, and a storage, wherein the controller is configured to store the received information in the storage, generate a music user interface (UI) where information regarding a plurality of music contents, including the music content and corresponding to audio signals which are generated by the microphone during a predetermined period of time, are arranged in an order of time of generating of the audio signals corresponding to the music contents, and control the display to display the generated music UI.

The controller may be configured to generate a playlist using at least one music content which is selected from the music UI according to a user input.

The music UI may include a plurality of graphic items respectively corresponding to the plurality of music contents, wherein the controller is configured to determine a size of each graphic item of the plurality of graphic items based on a length of time of generating a corresponding audio signal.

The electronic device may further include an audio output unit, wherein the controller is configured to, in response to at least one music content of the plurality of music contents included in the music UI being selected, determine a content providing service which provides the selected music content with best sound quality from among pre-registered content providing services, control the communicator to connect to the content providing service, and control the audio output unit to output a content which is provided by the content providing service.

The electronic device may further include an audio output unit, wherein the controller is configured to, in response to at least one music content of the plurality of music contents included in the music UI being selected, determine a content providing service which provides the selected music content for free from among pre-registered content providing services, control the communicator to connect to the content providing service, and control the audio output unit to output a content which is provided by the connected content providing service.

The controller may be configured to, in response to receiving an approval to use the content providing service or log-in request from the connected content providing service, control the communicator to connect to a corresponding service page.

The electronic device may further include a sensor configured to sense a user's approach, wherein the controller is configured to, in response to sensing a user's approach, control the display to display a notification message regarding the generated music UI.

The electronic device may further include a sensor configured to sense a user's approach, and a display, wherein the controller is configured to control the display to display the information in response to the sensor sensing a user's approach while the microphone generates the audio signal.

The controller may be configured to control the display to display an image related to the music content, and in response to receiving a user input to move the image, control the display to display other information regarding the music content while applying a folded paper effect to the displayed image.

According to an aspect of another exemplary embodiment, there is provided method of controlling an electronic device, the method including: generating, by a microphone, an audio signal based on a received sound; transmitting the audio signal to an external device; receiving the information regarding a music content corresponding to the audio signal from the external device; and displaying the information on a display.

The method may further include: storing the information in a storage; generating a music user interface (UI) where information regarding a plurality of music contents, including the music content and corresponding to audio signals which are generated by the microphone during a predetermined period of time, are arranged in an order of time of generating the audio signals corresponding to the music contents; and displaying the generated music UI.

The method may further include generating a playlist using at least one music content which is selected from the music UI according to a user input.

The music UI may include a plurality of graphic items respectively corresponding the plurality of music contents, wherein the displaying the generated music UI includes determining a size of each graphic item of the plurality of graphic items based on a length of time of generating a corresponding audio signal.

The method may further include: in response to at least one music content of the plurality of music contents being selected from the music UI, determining a content providing service which provides the selected at least one music content with best sound quality from among pre-registered content providing services; connecting to the content providing service; and outputting a content which is provided by the content providing service.

The method may further include: in response to at least one music content of the plurality of music contents included in the music UI being selected, determining a content providing service which provides the selected music content for free from among pre-registered content providing services; connecting to the content providing service; and outputting a content which is provided by the connected content providing service.

The method may further include in response to receiving an approval to use the content providing service or log-in request from the connected content providing service, connecting to a corresponding service page.

The method may further include in response to sensing a user's approach, displaying a notification message regarding the generated music UI.

The method may further include in response to sensing a user's approach while generating the audio signal, displaying the information regarding the music content corresponding to the audio signal.

The displaying the information regarding the music content may include displaying an image related to the music content, and in response to receiving a user input to move the image, displaying other information regarding the music content while applying a folded paper effect to the displayed image.

### BRIEF DESCRIPTION OF THE DRAWINGS

The above and/or other aspects will be more apparent by describing certain exemplary embodiments with reference to the accompanying drawings, in which:

FIG. 1 is a block diagram illustrating an electronic device according to an exemplary embodiment;

FIG. 2 is a block diagram of an electronic device according to an exemplary embodiment;

FIGS. 3A through 3C illustrate a method of selecting a music content corresponding to an audio signal using a music UI according to an exemplary embodiment;

FIGS. 4A and 4B illustrate a method of determining a size of graphic items according an exemplary embodiment;

FIG. 5 illustrates a method of selecting a content providing service, according to an exemplary embodiment;

FIGS. 6A through 6C illustrate a method of displaying information regarding a music content in response to sensing a user's approach, according to an exemplary embodiment;

FIGS. 7A and 7B illustrate a user interface to display information regarding a music content, according to an exemplary embodiment;

FIG. 8 illustrates a user interface to display information regarding music contents, according to another exemplary embodiment;

FIGS. 9A through 9C illustrate a method of playing a music content using multiple electronic devices according to an exemplary embodiment;

FIG. 10 is a flowchart illustrating a method of controlling an electronic device according to an exemplary embodiment; and

FIG. 11 is a flowchart illustrating a method of controlling an electronic device according to another exemplary embodiment.

### DETAILED DESCRIPTION

Hereinafter, exemplary embodiments of the present disclosure will be described in detail with reference to the accompanying drawings. In the following description, detailed descriptions of well-known functions or configurations will be omitted since they would unnecessarily obscure the subject matters of the inventive concept. The terms used in the exemplary embodiments of the present disclosure have been defined in consideration of the functions of the present disclosure, and they may vary depending on users, operators or precedents. Thus, the definition of the terms should be made in consideration of the overall contents of the present disclosure.

The terms such as “first” and “second” may be used to describe various elements, but the elements should not be limited by these terms. These terms may be used for the purpose of distinguishing one element from another element. For example, the first element may be referred to as the second element and similarly, the second element may be referred to as the first element without going beyond the scope of rights of the present disclosure. The term of “and/or” includes combination of a plurality of related item of one of the plurality of related items.

The terms in the present application are used to describe an exemplary embodiment and do not intend to restrict and/or limit the present disclosure. The singular forms are intended to include the plural forms as well, unless the context clearly indicates otherwise. In addition, it should be understood that the term “include” or “comprise” used in the exemplary embodiments of the present disclosure is to indicate the presence of features, numbers, steps, operations, elements, parts, or a combination thereof described in the specifications, and do not preclude the presence or addition of one or more other features, numbers, steps, operations, elements, parts, or a combination thereof.

In the present application, the terms “include” and “comprise” designate the presence of features, numbers, steps, operations, components, elements, or a combination thereof that are written in the specification, but do not exclude the presence or possibility of addition of one or more other features, numbers, steps, operations, components, elements, or a combination thereof.

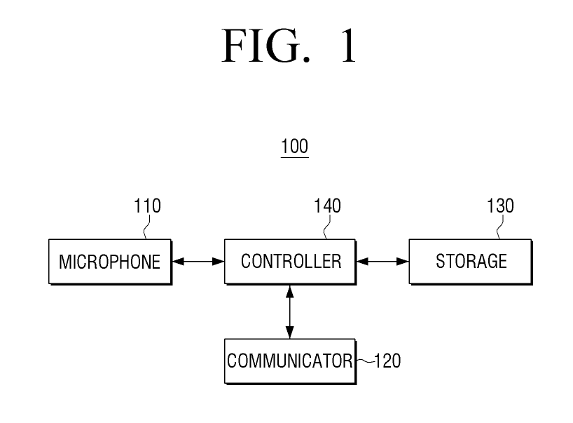

FIG. 1 is a block diagram illustrating an electronic device according to an exemplary embodiment. Referring to FIG. 1, the electronic device 100 may include a microphone 110, a communicator 120, a storage 130, and a controller 140.

The electronic device 100 may be realized as various devices, e.g., a speaker, a display such as a smart TV, a mobile device such as a smart phone, a wearable device such as a smart watch, a PC, a tablet PC, a navigation, an interactive voice recognition device, etc. Hereinafter, it is assumed that the electronic device 100 is an audio device with a display, but the electronic device 100 is not limited thereto.

The microphone 110 may obtain/generate an audio signal, i.e., convert received sound into an audio signal. For example, the microphone may receive a user voice, ambient music sound, telephone bell, domestic noise, etc. In addition, the microphone 110 may convert a received sound to an audio signal using an Analog to Digital Converter (ADC) (not shown), etc.

The communicator 120 may communicate with an external device. For example, the communicator 120 may transmit an audio signal, which is generated by the microphone 110, to an external device. In addition, the communicator 120 may receive information corresponding to the transmitted audio signal, e.g., information regarding a music content, from the external device. In another example, the communicator 120 may perform communication with a contents provider (CP). For example, the communicator 120 may transmit information regarding a music content request, log-in information, etc. to the CP and receive the music content from the CP in response.

The communicator 120 may perform communication with other electronic devices. For example, a plurality of electronic devices may be interlocked to each other and provide a stereo and/or a surround effect. The electronic devices may output different frequency components of the same sound source.

The storage 130 may store various data, programs or applications which are used to drive and control the electronic device 100. For example, the storage 130 may store an audio signal, information regarding a music content, an image related to a music content, a music content file, etc.

The controller 140 may control the overall operations of the electronic device 100. For example, the controller 140 may control the communicator 120 to transmit an audio signal to an external device and receive information regarding a music content corresponding to the audio signal from the external device. In addition, the controller 140 may store the received information regarding a music content in the storage 130.

The electronic device 100 may recognize a sound source which is being reproduced around the electronic device 100, collect information about the sound source, and provide the information to a user.

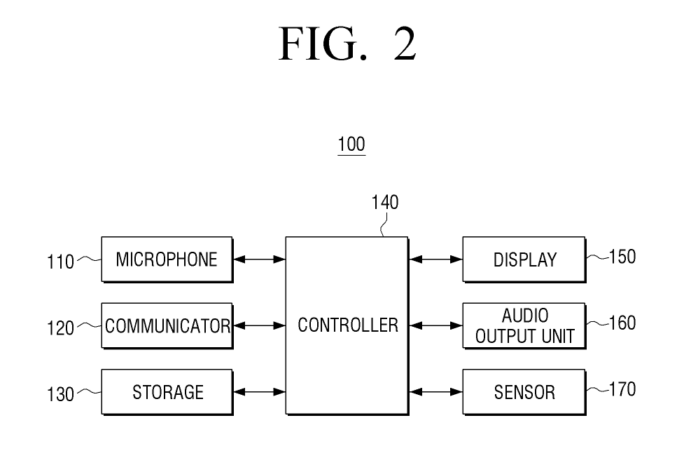

FIG. 2 is a block diagram of an electronic device according to an exemplary embodiment. Referring to FIG. 2, the electronic device 100 may include the microphone 110, the communicator 120, the storage 130, a display 150, an audio output unit 160, a sensor 170, and the controller 140.

The microphone 110 may obtain/generate an audio signal, i.e., convert received sound to an audio signal. For example, the microphone 110 may receive a user voice, background music of a TV program, music from radio, telephone bell, domestic noise, etc. The microphone may convert a received sound to an audio signal using an ADC. In addition, the microphone 110 may perform preprocessing such as removing noise in order to better recognize a sound source.

The communicator 120 may perform communication with an external device. Examples of the external device may include, but is not limited to, a cloud server, a home network hub device, another electronic device, etc. The communicator 120 may transmit an audio signal to an external device and receive information corresponding to the audio signal from the external device. In addition, the communicator 120 may transmit and/or receive control information, sync information, etc. to an external device. In another example, the communicator 120 may transmit information regarding a generated music content to an external device and store the information.

The communicator 120 may include various communication modules such as a near field wireless communication module, a wireless communication module, etc. The near field wireless communication module refers to a module which performs communication with an external device in the neighborhood according to a near field wireless communication such as Bluetooth, Zigbee, etc. The wireless communication module refers to a module which is connected to an external network to perform communication according to a wireless communication protocol such as WiFi, IEEE, etc. The wireless communication module may further include a mobile communication module which connects to a mobile communication network to perform communication according to various mobile communication standards such as 3rd Generation (3G), 3rd Generation Partnership Project (3GPP), Long Term Evolution (LTE), LTE Advanced (LTE-A), etc.

In addition, the communicator 120 may perform communication with an external device using a wired communication method. For example, the communicator 120 may transmit information regarding a generated music content, a music content itself, etc. to an external device using a wired communication method and store the same. The communicator 120 may use High Definition Multimedia Interface (HDMI), Low Voltage Differential Signaling (LVDS), Local Area Network (LAN), etc. as a wireless communication method.

The storage 130 may store an audio signal, a music content, information thereof, etc. The storage 130 is a storage medium where various programs necessary to operate the storage 100 is stored, and may be realized as a memory, a Hard Disk Drive (HDD), etc. For example, the storage 130 may include a ROM to store a program to perform the operation of the electronic device 100, a RAM to store data necessary to perform the operation of the electronic device 100 temporarily, etc. In addition, the storage 130 may further include an Electrically Erasable and Programmable ROM (EEPROM) to store various reference data, etc.

The storage 130 may pre-store a notification message, etc. to be provided to a user as a voice or a text. For example, the controller 140 may control the audio output unit 160 to provide information regarding a music content selected by a user input as a pre-stored voice. In addition, the controller 140 may control the display 150 to display a notification message notifying that a music user interface (UI) is generated, etc. using a pre-stored text.

The display 150 may display an image. The display 150 may be realized as a Liquid Crystal Display (LCD), an Organic Light Emitting Display (OLED) or a Plasma Display Panel (PDP), etc., and provide various display screens which can be provided through the electronic device 100.

The display 150 may display a music UI which is generated by the controller 140. For example, the display 150 may display a UI which provides music contents corresponding to audio signals obtained by the electronic device 100 for a certain period of time in the form of a list.

The display 150 may be realized in a touch screen format that forms a mutual layered structure with a touch pad, and the touch pad may be configured to detect the location, size and even pressure of a touch input. For example, the display 150 may display a UI and receive a user input to select a graphic item included in the UI using a touch screen.

The audio output unit 160 may output a voice. For example, the audio output unit 160 may output a music content received from a content providing service. In another example, the audio output unit 160 may output a voice message corresponding to a user command. The audio output unit 160 may provide a user with a user experience of communicating with the electronic device 100.

The sensor 170 may sense a user's approach. The sensor 170 may be realized as a proximity sensor, an illumination sensor, a ultrasonic sensor, a magnetic sensor, etc. For example, if a user's approach is sensed through the sensor 170, the controller 140 may control the display 150 to display a notification message notifying that there is a generated music UI or control the audio output unit 160 to output a voice message.

In another example, a user may approach the electronic device 100 while carrying a device where music is reproduced. If the user's approach is sensed through the sensor 170, the controller 140 may control the display 150 to display information regarding the music content which is currently reproduced using an audio signal obtained from the device that the user is carrying.

The controller 140 may control the overall configuration of the electronic device 100 including the above-described configuration. The controller 140 may control a plurality of hardware or software elements which are connected to the controller 140 by driving an operation system or an application, and perform processing of various data including music content data and operations. For example, the controller 140 may be realized in the form of a System on Chip (SoC), and may further include a Graphic Processing Unit (GPU).

The specific operations of the controller 140 will be described in further detail below.

The controller 140 may control the communicator 120 to transmit an audio signal, e.g., music, obtained through the microphone 110 to an external device and receive information regarding the audio signal from the external device. The controller 140 may store the received information in the storage 130. For example, the information may include an album image, singer information, related contents, etc.

According to an exemplary embodiment, the electronic device 100 may be installed around TV or home theater at home. Thus, when a user watches a TV, the electronic device 100 may obtain an audio signal corresponding to background music of the TV program the user is watching. When a user watches a movie through a home theater, the electronic device 100 may obtain an audio signal corresponding to the Original Sound Track (OST) of the movie. The controller 140 may transmit an audio signal, e.g., the background music or the OST obtained through the microphone 110 to an external device, receive information regarding the audio signal, e.g., a title of the background music, information about an album including the background music, etc., from the electronic device, and provide the information to the user.

As such, the electronic device 100 may collect and provide music information in real time, and thus a user can be provided with information regarding the music easily while watching TV without having to search the music while or after watching TV.

According to an exemplary embodiment, when power is applied to the electronic device 100, the controller 140 may start the above-described external sound source recognition function automatically. However, the controller 140 may perform the external sound source recognition function only under certain circumstances in consideration of power consumption, etc.

For example, the controller 140 may start the external sound source recognition function, i.e., obtaining an audio signal and receiving information regarding a music content, when TV or radio is turned on. If a user wishes to search music from TV or radio and make a playlist with the music, the controller 140 may start the operations automatically when the electronic device 100 is turned on. For example, the controller 140 may determine that TV or radio is turned on based on an audio signal coming from the TV or radio. Alternatively, the controller 140 may start obtaining an audio signal and receiving information regarding music content corresponding to the audio signal when the communicator 120 receives a signal indicating that TV is turned on through a home network.

In another example, the controller 140 may set to start or finish an external sound source recognition function based on whether lighting is turned on or off. The controller 140 may recognize whether lighting is turned on or off through an illumination sensor of the sensor 170. Also, the controller 140 may determine whether power is applied to lighting through a home network.

In another example, the controller 140 may perform an external sound source recognition function only during a specific time period. As there is little possibility of hearing a sound source around the electronic device 100 regarding which a user wishes to have information in the middle of the night, the controller 140 may disable the external sound source recognition function during a specific time period (for example, from 1:00 A.M. to 6:00 A.M.).

There may be a privacy issue if the user's conversation is recorded and a third party without the user's permission accesses the recorded conversation through hacking, etc. In this regard, when a user voice is received through the microphone 110, the controller 140 may stop the external sound source recognition function. By preventing user's conversation from being recorded, user's privacy can be protected. For example, the controller 140 may determine whether a user voice is received through the microphone 110 using pre-registered characteristics of the user voice.

According to an exemplary embodiment, the controller 140 may generate a music UI which arranges information regarding each of music contents in order of time of receiving a corresponding audio signal. The controller 140 may control the display 150 to display the generated music UI.

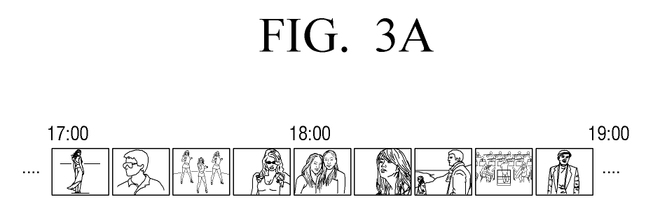

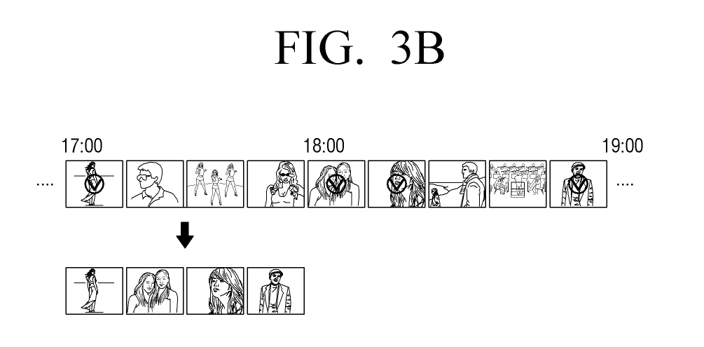

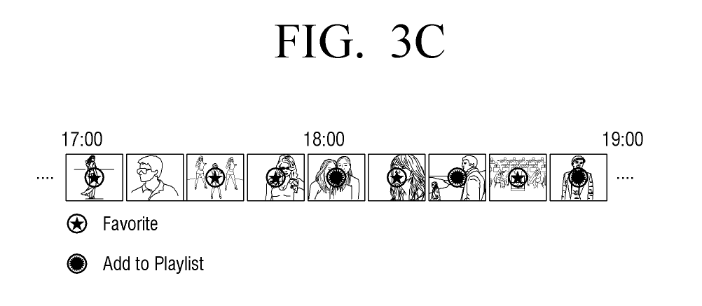

FIG. 3A illustrates a music UI according to an exemplary embodiment. The music UI may display information regarding multiple music contents corresponding audio signals obtained by the microphone 110 during a predetermined period of time. Referring to FIG. 3A, the music UI indicates that the electronic device 100 obtained audio signals corresponding to nine different music contents in the surroundings between 17:00 and 19:00, and the information regarding a music contents may be implemented using a graphic item. In FIG. 3A, the music UI displays the information in the form of thumbnails. If a user inputs a swipe in a left-and-right direction, the controller 140 may control the display 150 to display thumbnails corresponding to music contents which were recognized during a different time period. However, the swiping input is just an example of a user input to perform a search function, and the controller 140 may display information regarding music content which is recognized during a different time period using another input method, such as tapping left and right buttons.

As illustrated in FIG. 3A, the graphic item may be a cover image of an album which includes the corresponding music content. The controller 140 may provide a music UI in other form than a list. For example, the music UI may express the music UI in a box form, a circular form, etc. Also, the controller 140 may arrange information regarding music contents in a different manner. For example, the information may be arranged based on genre or mood.

The controller 140 may compose a playlist with at least one music content which is selected by a user from among at least one music content included in a music UI. As illustrated in FIG. 3B, if the first, fifth, sixth, and ninth items from among nine items are selected by a user, the controller 140 may compose a playlist with music contents corresponding to the selected items. The controller 140 may add the selected items, i.e., the selected music contents, to an existing playlist.

The controller 140 may add at least one music content which is selected by a user from among at least one music content included in a music UI to a favorite music list. FIG. 3C illustrates a music UI where contents to be added to a favorite and a playlist are selected. Referring to FIG. 3C, the controller 140 may add the first, third, fourth, sixth, and eighth items to a favorite music list. In addition, the controller 140 may add the selected items to an existing playlist.

According to an exemplary embodiment, the controller 140 may perform operations such as adding to a favorite music list, adding to a playlist, executing a sound source, etc. according to a user's different input on a touch screen. For example, the controller 140 may perform adding to a favorite music list in response to receiving a simple touch input, perform adding to a playlist in response to receiving a long-press input, and perform executing a music content in response to receiving a double click input. However, the user's input method is not limited to a touch input. Examples of the user's input method may include, but are not limited to, an input of a hardware key, an input by a remote controller, an input via a home network, etc.

According to an exemplary embodiment, a music UI may include a graphic item corresponding to a stored music content. In addition, the controller 140 may control the display 150 to determine a size of the graphic item according to the time when an audio signal corresponding to a music content is obtained.

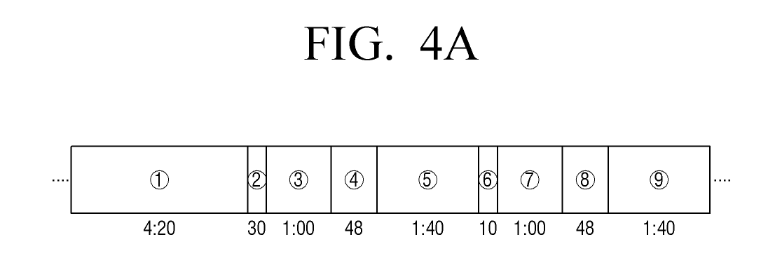

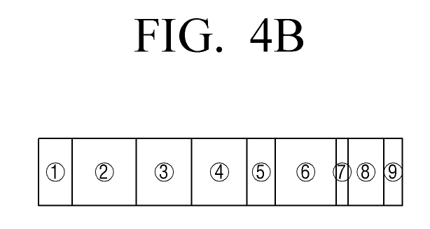

FIGS. 4A and 4B illustrate a method of adjusting a size of graphic items according an exemplary embodiment.

Referring to The controller 140 may adjust a size of a graphic item according to the time for which the corresponding audio signal is generated. Referring to FIG. 4A, the music UI shows that the audio signal corresponding to the first content was generated for 4 minutes and 20 seconds, and the audio signal corresponding the second content was generated for 30 seconds. In other words, the microphone 110 received the sound corresponding the first content during 4 minutes and 20 seconds and received the sound corresponding the second content for 30 seconds. The size of a graphic item is determined to be proportional to a length/period of time of receiving the sound the corresponding audio signal, so a user may recognize intuitively how long each music content had been played around the electronic device 100.

As illustrated in FIG. 4B, the controller 140 may control overlapping of the graphic items according to a length/period of time for generating an audio signal. For example, if a first audio signal was generated for a long time, the entire part of the corresponding graphic item will be displayed. On the other hand, if a second audio signal is generated for a relatively short time, some of the corresponding graphic item will be overlapped with the next graphic item, and thus only a part of the corresponding graphic item will be displayed.

According to an exemplary embodiment, the controller 140 may determine a user's preference based on information regarding music contents, which stored not only in the electronic device 100 but also in the user's other devices. The controller 140 may build database by combining information regarding stored music contents and information regarding music contents received from other external devices. The controller 140 may determine the user's music preferences, etc. based on the database. For example, the controller 140 may use information regarding music genre, etc. which is recorded in the metadata of a music content. The controller 140 may control the display 150 to display a UI for recommending other music contents to the user based on the determined music preferences. For example, only a particular genre may be recommended.

If one of the music contents included in the music UI is selected, the controller 140 may control the communicator 120 to connect to one of the pre-registered content providing services. Subsequently, the controller 140 may control the audio output unit 160 to output the selected music content provided by the connected content providing service.

The content providing service refers to a online service provided by a third-party business operator to provide contents through a network communication such as a streaming method, etc. Examples of the content providing service may include, but are not limited to, Samsung milk, Apple music, YouTube, Spotify, Pandora, Deezer, Melon, Genie music, Bugs music, etc.

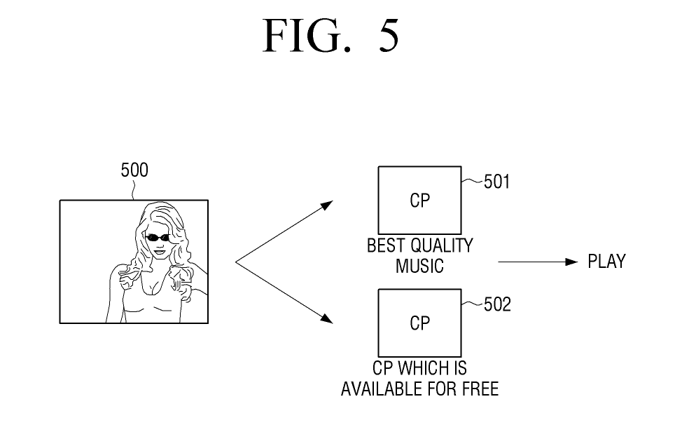

Sound quality of a music content may vary depending on a type of the content providing services. Some music contents may be charged by one content providing service while another content providing service provides the same content for free. Accordingly, the controller 140 need to determine a content providing service among pre-registered content providing services and control the communicator 120 to connect to the determined content providing service. FIG. 5 illustrates a method of selecting a content providing service, according to an exemplary embodiment.

For example, the controller 140 may connect to a content providing service 501 which provides best sound quality from among pre-registered content providing services in case a user sets sound quality as the most important selection standard. If a log-in or settlement is required by a connected content providing service or an approval to user music contents of the connected content providing service is received, the controller 140 may control the communicator 120 to connect to the corresponding service page. After log-in or settlement is completed in the corresponding service page, the controller 140 may request the content providing service to provide the selected music content 500 and control the audio output unit 160 to output the received music content.

In another example, the controller 140 may control the communicator 120 to connect to a content providing service 502 which provides a selected music content 500 for free of charge from among pre-registered content providing services. Likewise, if there is a request for log-in, etc. in the connected content providing service, the controller 140 may control the communicator 120 to connect to the corresponding service page.

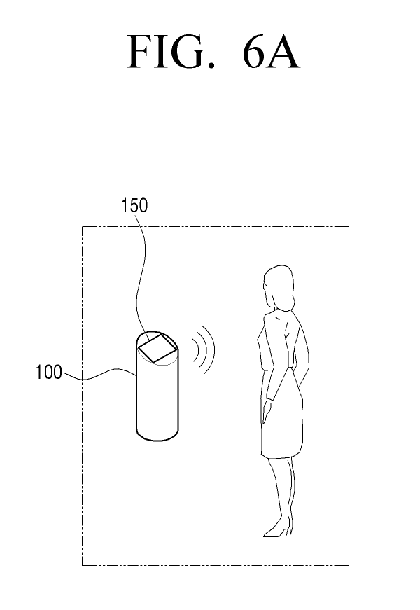

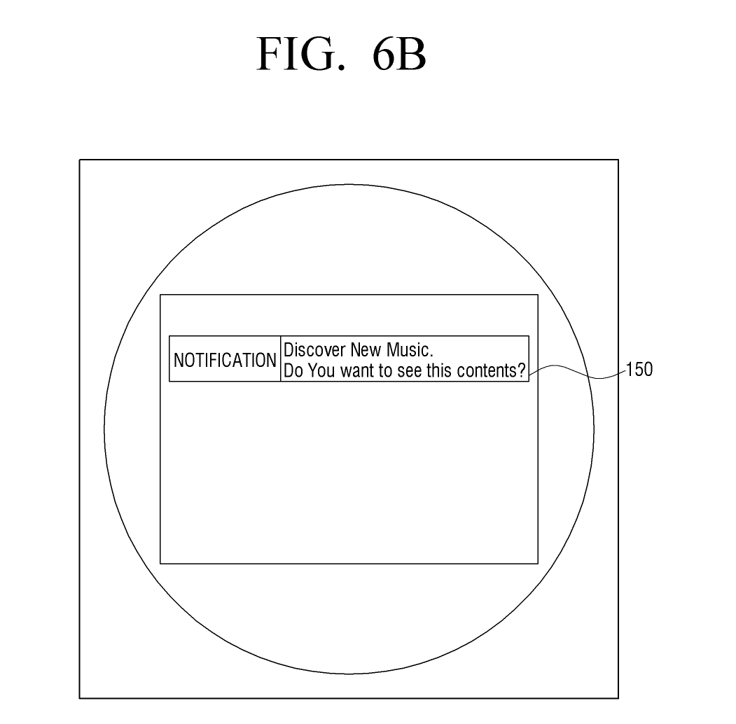

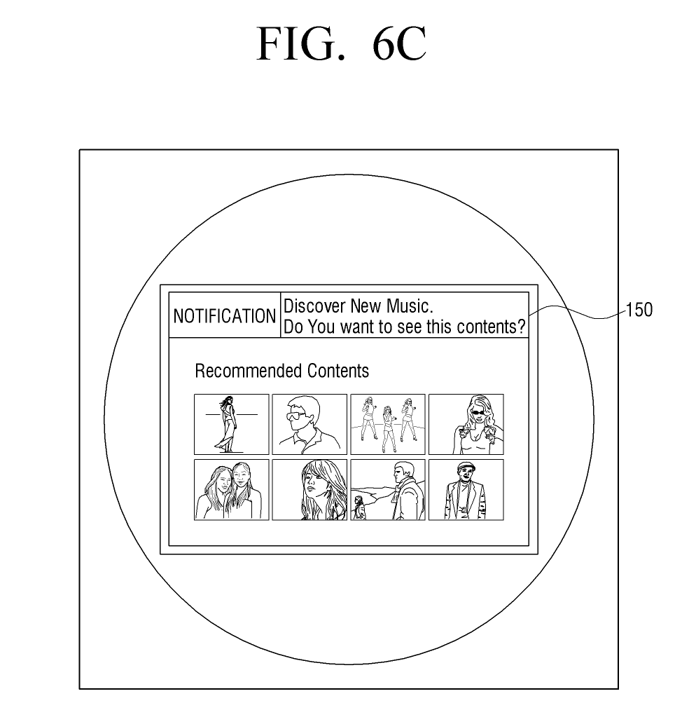

FIG. 6A through 6C illustrate a screen of an electronic device according to an exemplary embodiment. As illustrated in FIG. 6A, if a user's approach is sensed through the sensor 170, the controller 140 of the electronic device 100 may control the display 150 to display a notification message that there is a generated music UI. Accordingly, a user may be provided with information regarding a music content which is recognized automatically.

As illustrated in FIG. 6B, the controller 140 may control the display 150 to display a notification message such as ‘Discover New Music’ to notify that a music content is detected. In addition, the controller 140 may display a notification message and output a corresponding voice message simultaneously.

The notification message may be provided along with recommended contents as shown in FIG. 6C. For example, if there is a user input after the notification message of FIG. 6B is displayed, the controller 140 may control the display 150 to display information regarding the detected music, e.g., recommended contents, as shown in FIG. 6C. In another example, the controller 140 may control the display 150 to display the information regarding the detected music immediately without further user input.

According to another exemplary embodiment, if a user's approach is sensed through the sensor 170 while an audio signal is being obtained/generated, the controller 140 may control the display 150 to display information regarding a music content corresponding to the audio signal. For example, if a user approaches the electronic device 100 while listening to music through a mobile device, the controller 140 may show information regarding the music that he or she is currently hearing through the mobile device. For example, the electronic device may show a list of other albums released recently by the same singer.

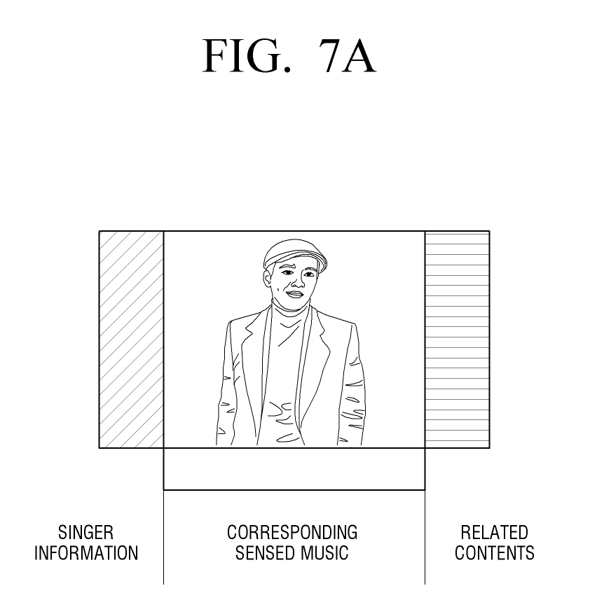

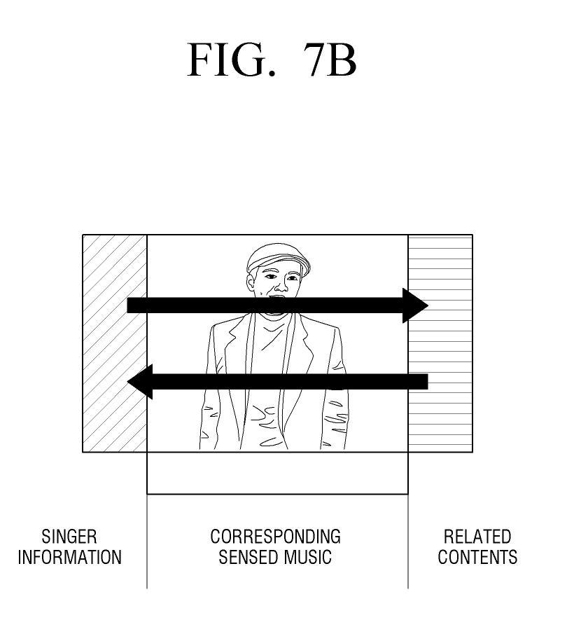

FIGS. 7A and 7B illustrate a user interface to display information regarding a music content, according to an exemplary embodiment. The UI for providing information related to a music content may be configured in various forms. For example, as illustrated in FIG. 7A, the controller 140 may configure a UI to display information regarding a currently-sensed music content in the middle area (for example, information regarding album title, singer, date of release, genre, releasing company, etc.). In addition, the controller 140 may configure a UI to display additional information on an edge area. As illustrated in FIG. 7A, the controller 140 may configure a UI such that information regarding a corresponding singer is displayed on the left side and related contents are displayed on the right side.

As illustrated in FIG. 7B, according to a user input, the controller 140 may control the display 150 to change the location of the information regarding a music content, singer, related contents, etc.

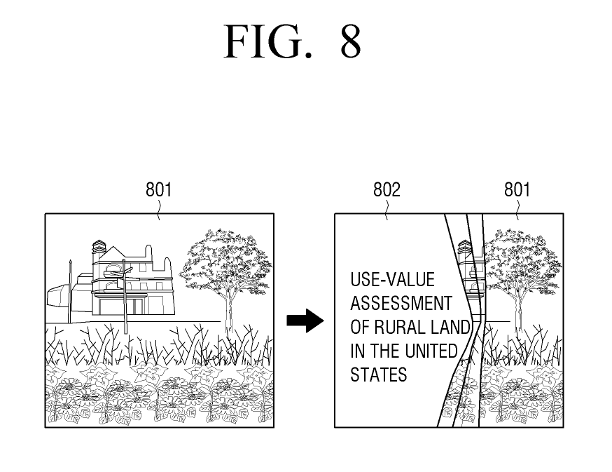

FIG. 8 illustrates a user interface to provide information regarding a music content, according to another exemplary embodiment. As illustrated in FIG. 8, the controller 140 may control the display 150 to display an image 801 related to a music content. If a user input to move the displayed image is received, the controller 140 may control the display 150 such that information 802 regarding corresponding music content is displayed while the displayed image 801 is folded. In other words, a folded paper effect is applied to the displayed image 801, as shown in FIG. 8. The UI illustrated in FIG. 8 may be referred to as ‘Peeping UI’ in that the UI is configured for a user to peep at the displayed image.

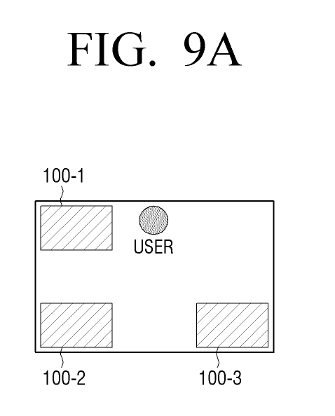

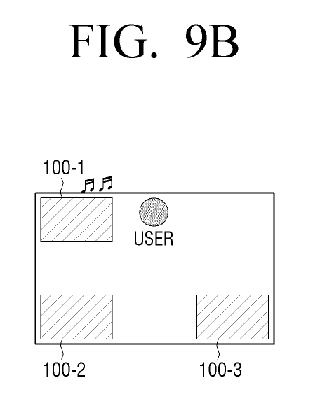

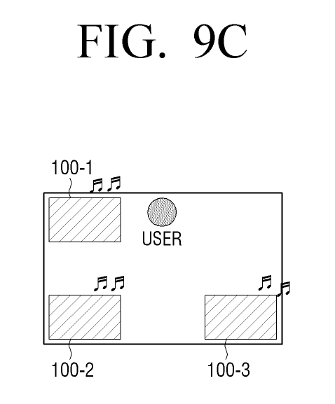

According to an exemplary embodiment, a plurality of electronic devices 100-1, 100-2, 100-3, . . . may link with each other to provide a surround effect to a user. This “group play function” will be described with reference to FIGS. 9A through 9C.

Referring to FIG. 9A, there are three electronic devices 100-1, 100-2, 100-3 in a space where a user is located. Subsequently, as illustrated in FIG. 9B, the first electronic device 100-1 from among the electronic devices 100-1, 100-2, 100-3 may output a music content according to a user command. The remaining electronic devices 100-2, 100-3 may obtain an audio signal corresponding to the music content which is output from the first electronic device 100-1 as they are located close to the first electronic device 100-1.

Using the obtained audio signal, the remaining electronic devices 100-2, 100-3 may receive a corresponding music content from a content providing service. As a result, the electronic devices 100-1, 100-2, and 100-3 may output the same music content.

According to an exemplary embodiment, the plurality of electronic devices 100-1, 100-2, and 100-3 may generate a surround effect by outputting the same music content in different frequency bands. To do so, each of the different frequency bands need to be properly assigned to the electronic devices 100-1, 100-2, 100-3. For example, the electronic devices 100-1, 100-2, 100-3 may be connected to a home network, etc. and share sync information, frequency band information, etc. By sharing only sync information and frequency band information which takes up small amount of data without sharing a music content file itself, the electronic devices 100-1, 100-2, 100-3 may provide an group play function more effectively.

Based on the location of the first electronic device 100-1 where a user command is input, the remaining electronic devices 100-2, 100-3 may adjust a frequency band so that a desired sound effect can be generated at the location of the first electronic device 100-1. The plurality of electronic devices 100-1, 100-2, and 100-3 may recognize their relative locations using GPS. In addition, the electronic devices 100-1, 100-2, and 100-3 may recognize their relative locations by measuring distance between the devices using a short range communication protocol such as Bluetooth. An algorithm for determining the locations of the electronic devices is not limited to a particular one.

According to an exemplary embodiment, each of the electronic devices 100-1, 100-2, and 100-3 may transmit music information, which identifies detected music, to an external device and the external device stores the music information. Accordingly, the music information generated by the electronic devices 100-1, 100-2, and 100-3 may be managed in an integrated manner.

For example, the electronic devices 100-1, 100-2, and 100-3 may send their location information along with music information to an external device. If the electronic devices 100-1, 100-2, 100-3 are located at a living room, a dining room, and a bedroom, respectively, a user's preferred music according to a user's behavior pattern can be determined based on the location information of the electronic devices 100-1, 100-2, 100-3. The electronic device 100 may provide an improved music recommendation function, etc. which reflects the user's behavior pattern using the integrated information. If the electronic devices 100-1, 100-2, and 100-3 are registered in a home network, the electronic device 100 may omit transmitting location information separately.

The electronic devices 100-1, 100-2, 100-3 may store music information in an external device, but may also transmit the music information to one of the electronic devices 100-1, 100-2, 100-3 so that the one electronic device can manage the music information in an integrated manner. For example, the electronic device 100-1 which is installed at a place where a user spends most of his or her time may be set as a master device from among the plurality of electronic devices 100-1, 100-2, and 100-3.

According to an exemplary embodiment, if a predetermined voice or sound is received through the microphone 110 while a music content is output through the audio output unit 160, the controller 140 may generate a control signal to perform an operation corresponding to the predetermined voice or sound. The controller 140 may store context information corresponding to the predetermined voice or sound in storage in advance. The context information may include information which identifies the predetermined voice or sound. The context information may include information about frequency characteristics of the predetermined voice or sound.

For example, if a sound of a telephone ringing is detected while a music content is output, the controller 140 may control the audio output unit 160 to lower the volume of the music content. Accordingly, a user may have phone conversation conveniently without adjusting the electronic device 100.

On the other hand, if a sound recognized as noise is received, the controller 140 may control the audio output unit 160 to increase the volume of a music content. For example, if a noise of a vacuum cleaner is received through the microphone 110, the controller 140 may control the audio output unit 160 to increase the volume of the music content and output the music content with the increased volume.

In another example, if a sound of baby crying is received through the microphone 110, the controller 140 may control the audio output unit 160 to reproduce a music content for kids, e.g., a lullaby, a child animation theme song, etc. The sound of baby crying is different from a voice of an adult in terms of frequency characteristics, the controller 140 may recognize the sound of baby crying by analyzing a voice signal which is input through the microphone 110.

According to an exemplary embodiment, the controller 140 may collect user's body information as context information to determine a music content to play. The body information may be collected through a wearable device the user is wearing. For example, if a user wearing a wearable device approaches the electronic device 100, the controller 140 may control the communicator 120 to transmit a signal for requesting body information, i.e., stress index, to the wearable device. Subsequently, the controller 140 may receive the user's body information from the wearable device through the communicator 120. If it is determined that the user's stress index is high, the controller 140 may control the audio output unit 160 to reproduce a music content which is likely to lower the stress index. For example, a music which successfully lowered the user's stress index in the past may be selected.

As described above, according to the various exemplary embodiments, the electronic device 100 may recognize an external sound source automatically and provide a list of the recognized music contents to the user. Therefore, the user may easily create a playlist using the recognized music contents. In addition, the electronic device 100 may recommend to the user additional contents related to the recognized music by analyzing the user's preferences.

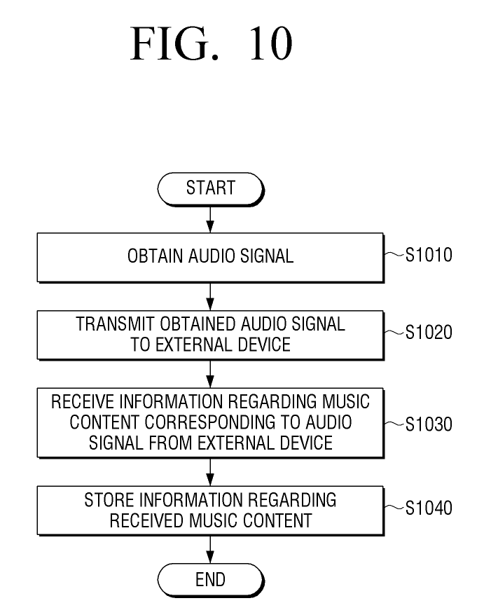

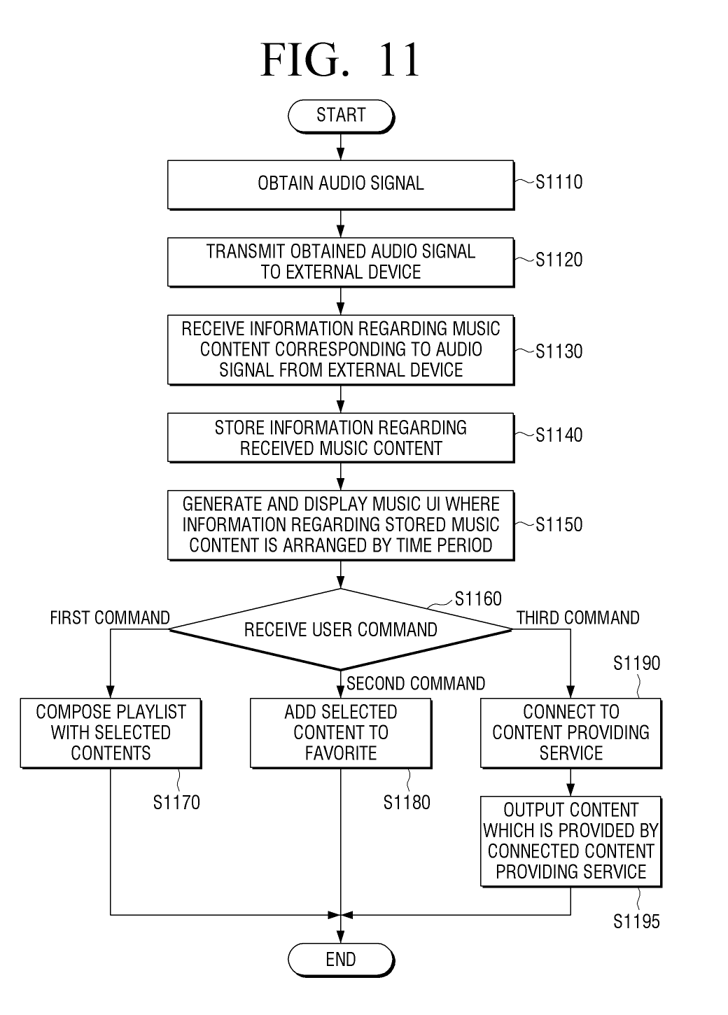

Hereinafter, a method of controlling the electronic device 100 according to an exemplary embodiment will be described with reference to FIGS. 10 and 11.

FIG. 10 is a flowchart illustrating a method of controlling the electronic device 100 according to an exemplary embodiment.

In operation S1010, the electronic device 100 may obtain an audio signal through a microphone.

In operation S1020, the electronic device 100 may transmit the obtained audio signal to an external device. The audio signal may be analyzed to identify a sound source by the electronic device 100 or in the external device. For example, voice recognition operation may be performed with respect to the audio signal.

In operation S1030, the electronic device 100 may receive information regarding a music content corresponding to an audio signal from an external device. For example, the information regarding a music content may include, but is not limited to, a song title, singer, and/or a composer name. In addition, the electronic device 100 may further receive additional information related to the music content, such as new album released by the same singer, a movie trailer in which the music content is used, etc.

In operation S1040, the electronic device 100 may store the received information regarding the music content.

As a result, the electronic device 100 may detect ambient voices in real time and store information regarding the collected voices.

FIG. 11 is a flowchart illustrating a method of controlling an electronic device according to an exemplary embodiment. The operations S1110 through S1140 of FIG. 11 correspond to operations S1010 through S1040 of FIG. 10, so the descriptions thereof will not be repeated here.

In operation S1150, the electronic device 100 may generate and display a music UI where information regarding the recognized music contents are arranged in order of time of generating corresponding audio signals. Further, the electronic device 100 may determine a size of a graphic item included in the music UI according to the length/period of time of generating corresponding audio signals, as shown in FIG. 4A. As a result, the length of time of generating each audio signal can be recognized intuitively. In an exemplary embodiment, the music UI may arrange the information regarding the music contents by genre or mood.

In operation S1160, the electronic device 100 may receive a user command to perform various operations using the generated music UI.

In operation S1170, according to a first command, at least one music content, e.g., an item representing the music content, included in the music UI is selected, and the electronic device 100 may create a playlist with the selected music content.

In operation S1180, according to a second command, at least one music content included in the music UI is selected, and the electronic device 100 may add the selected music content to a favorite music list.

In operation S1190, according to a third command, at least one music content included in the music UI is selected, and the electronic device 100 may connect to at least one pre-registered content providing service. The electronic device 100 may select a content providing service among many content providing services, which provides a sound source with best sound quality with respect to a selected content. The electronic device 100 may select a content providing service among many content providing services, which provides the selected content free of charge. If settlement or log-in is requested from a connected content providing service, the electronic device 100 may first connect to a corresponding service page.

In operation S1195, the electronic device 100 may output a music content which is provided by the connected content providing service.

According to an exemplary embodiment, the electronic device 100 may sense a user's approach and output a notification message or information regarding a music content. For example, if a user's approach is sensed through a proximity sensor, etc., the electronic device 100 may display a notification message regarding a generated music UI. If a user's approach is sensed while an audio signal is being received, the electronic device 100 may display information regarding a music content corresponding to the audio signal.

The above-described methods may be realized in the form of a program command which can be executed through various computer means (e.g., a processor) and recorded in a computer readable recording medium. The computer readable recording medium may include magnetic media such as a hard disk, a floppy disk, and a magnetic tape, optical media such as a CD-ROM and a DVD, magneto-optical media such as a floptical disk, and a hardware device particularly configured to store and perform a program command like an ROM, an RAM, a flash memory, etc. Examples of the program commands include a machine language code that is made by a compiler and a high-level language code that may be executed by a computer by using an interpreter or the like. The hardware device may be configured to operate as one or more software modules so as to perform operations of the exemplary embodiments and vice versa.

The foregoing embodiments and advantages are merely exemplary and are not to be construed as limiting the inventive concept. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

What is claimed is:

1. An electronic device comprising:
a microphone configured to receive sound and generate an audio signal based on the sound;
a communicator configured to perform communication with an external device; and
a controller configured to control the communicator to transmit the audio signal to external device and receive information regarding music content corresponding to the audio signal from the external device.

2. The electronic device as claimed in claim 1, further comprising:
a display; and
a storage,
wherein the controller is configured to store the received information in the storage, generate a music user interface (UI) where information regarding a plurality of music contents, including the music content and corresponding to audio signals which are generated by the microphone during a predetermined period of time, are arranged in an order of time of generating of the audio signals corresponding to the music contents, and control the display to display the generated music UI.

3. The electronic device as claimed in claim 2, wherein the controller is configured to generate a playlist using at least one music content which is selected from the music UI according to a user input.

4. The electronic device as claimed in claim 2, wherein the music UI includes a plurality of graphic items respectively corresponding to the plurality of music contents, wherein the controller is configured to determine a size of each graphic item of the plurality of graphic items based on a length of time of generating a corresponding audio signal.

5. The electronic device as claimed in claim 2, further comprising:
an audio output unit,
wherein the controller is configured to, in response to at least one music content of the plurality of music contents included in the music UI being selected, determine a content providing service which provides the selected music content with best sound quality from among pre-registered content providing services, control the communicator to connect to the content providing service, and control the audio output unit to output a content which is provided by the content providing service.

6. The electronic device as claimed in claim 2, further comprising:
an audio output unit,
wherein the controller is configured to, in response to at least one music content of the plurality of music contents included in the music UI being selected, determine a content providing service which provides the selected music content for free from among pre-registered content providing services, control the communicator to connect to the content providing service, and control the audio output unit to output a content which is provided by the connected content providing service.

7. The electronic device as claimed in claim 5, wherein the controller is configured to, in response to receiving an approval to use the content providing service or log-in request from the connected content providing service, control the communicator to connect to a corresponding service page.

8. The electronic device as claimed in claim 2, further comprising:
a sensor configured to sense a user's approach,
wherein the controller is configured to, in response to sensing a user's approach, control the display to display a notification message regarding the generated music UI.

9. The electronic device as claimed in claim 1, further comprising:
a sensor configured to sense a user's approach; and
a display,
wherein the controller is configured to control the display to display the information in response to the sensor sensing a user's approach while the microphone generates the audio signal.

10. The electronic device as claimed in claim 9, wherein the controller is configured to control the display to display an image related to the music content, and in response to receiving a user input to move the image, control the display to display other information regarding the music content while applying a folded paper effect to the displayed image.

11. A method of controlling an electronic device, the method comprising:
generating, by a microphone, an audio signal based on a received sound;
transmitting the audio signal to an external device;
receiving the information regarding a music content corresponding to the audio signal from the external device; and
displaying the information on a display.

12. The method as claimed in claim 11, further comprising:
storing the information in a storage;
generating a music user interface (UI) where information regarding a plurality of music contents, including the music content and corresponding to audio signals which are generated by the microphone during a predetermined period of time, are arranged in an order of time of generating the audio signals corresponding to the music contents; and
displaying the generated music UI.

13. The method as claimed in claim 12, further comprising:
generating a playlist using at least one music content which is selected from the music UI according to a user input.

14. The method as claimed in claim 12, wherein the music UI includes a plurality of graphic items respectively corresponding the plurality of music contents,
wherein the displaying the generated music UI comprises determining a size of each graphic item of the plurality of graphic items based on a length of time of generating a corresponding audio signal.

15. The method as claimed in claim 12, further comprising:
in response to at least one music content of the plurality of music contents being selected from the music UI, determining a content providing service which provides the selected at least one music content with best sound quality from among pre-registered content providing services;
connecting to the content providing service; and
outputting a content which is provided by the content providing service.

16. The method as claimed in claim 12, further comprising:
in response to at least one music content of the plurality of music contents included in the music UI being selected, determining a content providing service which provides the selected music content for free from among pre-registered content providing services;
connecting to the content providing service; and
outputting a content which is provided by the connected content providing service.

17. The method as claimed in claim 15, further comprising:
in response to receiving an approval to use the content providing service or log-in request from the connected content providing service, connecting to a corresponding service page.

18. The method as claimed in claim 12, further comprising:
in response to sensing a user's approach, displaying a notification message regarding the generated music UI.

19. The method as claimed in claim 11, further comprising:
in response to sensing a user's approach while generating the audio signal, displaying the information regarding the music content corresponding to the audio signal.

20. The method as claimed in claim 19, wherein the displaying the information regarding the music content comprises displaying an image related to the music content, and in response to receiving a user input to move the image, displaying other information regarding the music content while applying a folded paper effect to the displayed image.
